(19) United States
(12) Patent Application Publication
(10) Pub. No.: US 2008/0057297 A1
(43) Pub. Date: Mar. 6, 2008

(54) OPTICAL MULTI-LAYER SHEET AND IMAGE DISPLAY DEVICE

(75) Inventors: Akira Hatakeyama, Fujinomiya-shi (JP); Tatsuya Nomura, Fujinomiya-shi (JP); Takashi Kobayashi, Fujinomiya-shi (JP); Katsuyoshi Suzuki, Fujinomiya-shi (JP); Naoya Imamura, Fujinomiya-shi (JP); Takafumi Saiki, Fujinomiya-shi (JP); Sumio Nishikawa, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/843,304

(22) Filed: Aug. 22, 2007

(30) Foreign Application Priority Data
Aug. 22, 2006 (JP) 2006-225375
Mar. 12, 2007 (JP) 2007-061241

(51) Int. Cl. B32B 5/16; B32B 17/06; B32B 27/06; B32B 9/04; B32B 27/36

(52) U.S. Cl. 428/325; 428/327; 428/426; 428/447; 428/480

(57) ABSTRACT

An optical functional layer is formed on a first surface of a base material formed of polyester biaxially stretched. A protective material is formed on a second surface of the base material. The protective material includes fine particles, a lubricant, and a binder. The fine particles are formed of organic compound or inorganic compound. The binder is a polymer having a glass transition temperature of 40° C. or more. The lubricating properties of the surface are improved by the lubricant. As the lubricating properties improve, a necessary additional amount of the fine particles becomes less. Thereby, it is possible to prevent the degree of transparency from decreasing. Accordingly, the multi-layer sheet having high degree of transparency and excellent resistance to flaws can be obtained. It is possible to reduce bright unevenness by using the multi-layer sheet as the diffusion sheet.

### FIELD OF THE INVENTION

The present invention relates to an optical multi-layer sheet, and an image display device such as a liquid crystal display (LCD), a plasma display (PDP), an organic electroluminescence display (organic EL display), surface-conduction electron-emitter display (SED), a cathode ray tube display (CRT display), or the like using the optical multi-layer sheet as its component.

### BACKGROUND OF THE INVENTION

As an image display device for achieving high definition, a LCD, a PDP, an EL display device, and the like have been attracting attention. Among them, the LCD is thinner and lighter than other image display devices. Therefore the LCD is used for a widescreen TV, portable electronics, and the like, and the demand for the LCD is drastically increasing. The LCD is mainly composed of a liquid crystal cell obtained by filling a special liquid between glass plates, and a polarizing filter. A voltage is applied to the liquid crystal cell to change orientation of liquid crystal molecules. Thereby, transmittance of light is increased or decreased to display an image. Further, in order to keep high definition, the LCD adopts an optical sheet having an optical function such as a prism sheet, a light diffusion sheet, anti-reflection sheet, and a hard coat sheet to prevent reflection and diffusion of light and protect the polarizing filter. For example, a light diffusion sheet is described in detail in Japanese Patent Laid-Open Publication No. 2006-095980.

In general, the optical sheet is mainly a multi-layer sheet in which an optical functional layer such as a light diffusion layer, an anti-reflection layer, and a hard coat layer having light diffusion or condensation properties is formed on a surface of a base material formed of a transparent resin. A material for forming an optical functional layer is applied to the surface of the base material to be transported, and dried to produce the optical sheet.

A high degree of transparency is required in such a multi-layer sheet. Further it is required that the multi-layer sheet has few flaws on the surface or has resistance to flaws, since due to minute flaws on the surface, contrast of display image is decreased and brightness unevenness occurs, thus resulting in decrease in the image quality. However, when a multi-layer sheet is produced, the surface of the base material easily has flaws in applying materials to the surface of the base material, transporting the multi-layer sheet, or stacking the produced multi-layer sheets. In this case, there is known a method for improving lubricating properties by adding fine particles to the optical functional layer to prevent flaws on the surface of the base material.

For example, in Japanese Patent Laid-Open Publication No. 2004-004598, there is proposed a multi-layer sheet in which an optical functional layer including a polymer composition containing polyester polyol or acrylic polyol and minute inorganic fine particles is formed to achieve high degree of transparency and decrease in brightness unevenness. Further, in Japanese Patent Laid-Open Publication No. 2007-152887 (corresponding to Japanese Patent Application No. 2005-354908), there is proposed a multi-layer sheet in which a coating layer containing fine particles being formed of organic compound or inorganic compound, a binder, and a lubricant is formed on at least one surface of base material to achieve high degree of transparency and resistance to flaws.

However, according to Japanese Patent Laid-Open Publication No. 2004-004598, although it is possible to decrease brightness unevenness caused by deflection or discoloration on the sheet due to heat, UV rays, or the like, it is impossible to decrease flaws caused during transportation of the sheet. Additionally, since a large amount of fine particles are added thereto, flaws may occur by decrease in the degree of transparency or floating of the fine particles. According to Japanese Patent Laid-Open Publication No. 2007-152887, since only the resistance to flaws at a side on which the optical functional layer is formed is improved, there arises a problem about how to improve resistance to flaws on the another side of the base material.

### SUMMARY OF THE INVENTION

In view of the above, an object of the present invention is to provide an optical multi-layer sheet having high degree of transparency, resistance to flaws on its surface, and an image display device using the same.

According to the present invention, there is provided an optical multi-layer sheet characterized by including: a base material formed of polyester; an optical functional layer formed on a first surface of the base material; and a protective material formed on a second surface of the base material. The protective material includes fine particles, a lubricant, and a binder. The fine particles are formed of organic compound or inorganic compound. The binder is a polymer having a glass transition temperature of 40° C. or more.

Note that the base material is preferably biaxially stretched in advance. Further, the lubricant is preferably at least any one of wax, a silicone, and a compound represented by any one of the following General Formulae I, II, and III shown in Chemical Formula 2, 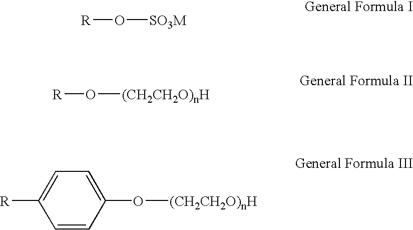
in which “R” denotes substituted or unsubstituted alkyl group, “n” denotes an integer in the range of 3 to 20, and “M” denotes a monovalent metal atom.

Moreover, the fine particles are preferably at least any one of polystyrene, polymethylmethacrylate, and silica. An average diameter of the fine particles is preferably not less than 0.05 μm and not more than 20.00 μm.

The fine particles preferably include first monodispersed fine particles and second monodispersed fine particles whose average diameters are different from each other.

Further, the protective material is preferably composed of two layers. The two layers are a fine particle-containing layer including fine particles and a binder, and a surface layer including a lubricant and a binder. The fine particles are formed of organic compound or inorganic compound. The binder is a polymer having a glass transition temperature of 40° C. or more. The surface layer is formed on the fine particle-containing layer.

According to the present invention, there is provided an image display device characterized by including any one of the above multi-layer sheets.

According to the multi-layer sheet of the present invention, the protective material is formed on the second layer of the base material formed of polyester. The base material has the optical functional layer as the optical sheet formed on the first surface. The protective material includes fine particles, a lubricant, and a binder. The fine particles are formed of organic compound or inorganic compound. The binder is a polymer having a glass transition temperature of 40° C. or more. Accordingly, upon being formed as the optical functional layer, for example, the optical diffusion layer can be used as the diffusion sheet that is a main component of the LCD backlight unit and has excellent resistance to flaws at the side of the light. Further, since the base material is biaxially stretched, the mechanical strength can be enhanced. Moreover, since the lubricant serves for improving the lubricating properties, it is possible to reduce the additional amount of the fine particles, keeping the lubricating properties, and prevent the degree of transparency from decreasing. Thereby, it is possible to provide the multi-layer sheet having high degree of transparency and excellent resistance to flaws, and the image display device achieving high definition using the multi-layer sheet.

### BRIEF DESCRIPTION OF THE DRAWINGS

One with ordinary skill in the art would easily understand the above-described objects and advantages of the present invention when the following detailed description is read with reference to the drawings attached hereto:

FIG. 1A is a schematic cross-sectional view exemplifying a multi-layer sheet according to an embodiment of the present invention;

FIG. 1B is an explanatory view of the protective material shown in FIG. 1A.

FIG. 2A is a schematic cross-sectional view exemplifying a multi-layer sheet having a protective material composed of two layers;

FIG. 2B is an explanatory view of the protective material shown in FIG. 2A.

FIG. 3 is a schematic cross-sectional view exemplifying a diffusion sheet having a light diffusion layer; and

FIG. 4 is a schematic perspective view of a backlight unit composed of diffusion sheets.

### DESCRIPTION OF THE PREFERRED EMBODIMENTS

Hereinafter, a multi-layer sheet according to the present invention is explained in detail by referring to Embodiments.

However, the present invention is not limited thereto.

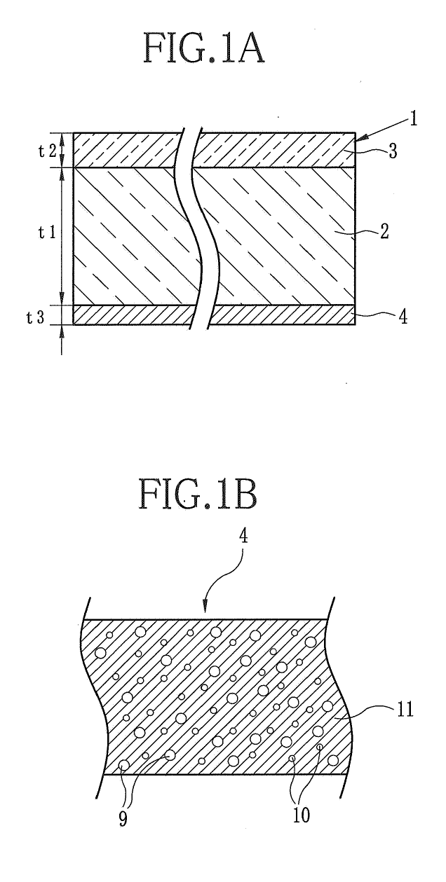

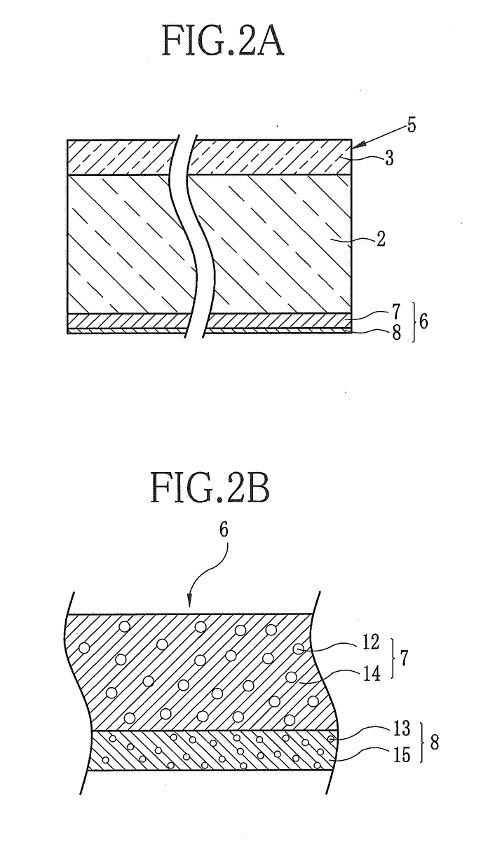

As shown in FIG. 1A, a multi-layer sheet 1 includes a base material 2 formed of polyester, an optical functional layer 3 formed on a first surface of the base material 2, and a protective material 4 formed on a second surface thereof. Note that instead of the protective material 4 composed of one layer as shown in FIG. 1A, a multi-layer 5 may include a protective material 6 composed of two layers having a fine particle-containing layer 7 and a surface layer 8 as shown in FIG. 2A. Further, the multi-layer sheet shown in FIGS. 1A and 2A may include an undercoat layer. Note that the undercoat layer is omitted in FIGS. 1A and 2A.

[Base Material]

Polyester used for the base material 2 is not especially limited, and well-known ones for optical use can be used. Concretely, there are polyethylene terephthalate, polyethylene naphthalate, polybutylene terephthalate, polybutylene naphthalate, and the like, for example. Among them, in view of manufacturing cost, mechanical strength, or the like, polyethylene terephthalate is preferably used.

The base material 2 of the present invention is preferably biaxially stretched. The biaxially stretching means that, when each of the width direction and the longitudinal direction of the base material 2 is considered as one axis, the base material 2 is stretched in both directions. The biaxial molecular orientation of the base material 2 as described above is sufficiently controlled, and therefore the base material 2 has improved mechanical strength. Although the draw ratio thereof is not especially limited, the draw ratio in one direction is preferably 1.5 to 7 times, and more preferably 2 to 5 times. In particular, molecular orientation of the base material 2 obtained by being biaxially stretched with the draw ratio in each direction of 2 to 5 times is preferable. When the draw ratio of the base material 2 is less than 1.5 times, it is not possible to obtain sufficient mechanical strength. On the contrary, the draw ratio thereof exceeds 7 times, it becomes difficult to obtain uniform thickness.

The draw ratio of the base material 2 is preferably controlled such that a thickness t1 (μm) of the base material 2 is in the range of 30 μm to 400 μm, and more preferably in the range of 35 μm to 350 μm. The base material 2 as described above has high degree of transparency, and is light and easy to be handled. However, the base material 2 having the width t1 of less than 30 μm may be too thin and difficult to be handled. On the contrary, the base material 2 having the width t1 of more than 400 μm may be too thick and unsuitable, since the base material 2 having the width d1 of more than 400 μm has difficulty in downsizing and lighting of an image display device and causes an increase in manufacturing cost.

[Optical Functional Layer]

The optical functional layer 3 may be a light diffusion layer, an antireflection layer, a prism layer, an antiglare layer, or the like, which is selectively used to obtain a sheet having a desired optical function. The multi-layer sheet 1 is used for not only the LCD but also other display devices such as a PDP, an organic EL display, a CRT display, or the like. Further, when the optical functional layer 3 having excellent mechanical strength, such as a hard coat layer, is formed, it is possible to achieve hardness without spoiling the optical function and prevent adhesion of dirt. Here, light diffusion means scattering of light due to its reflection or transmission.

The formation method of the optical functional layer 3 is not especially limited, and a well-known application method is selectively used in accordance with the purpose. For example, there are a spin coater, a roll coater, a bar coater, a curtain coater, and the like. According to any method, after a solution containing the materials for forming the optical functional layer 3 is applied to a target surface, the surface is dried to obtain the layer. Here, the drying method is not especially limited, and methods generally used can be selectively used. The drying temperature is preferably in the range of 90° C. to 130° C., and more preferably in the range of 100° C. to 120° C., since it is possible to perform drying in a short period of time without causing damage due to heat on the optical functional layer or the like. When the drying temperature is less than 90° C., the drying time may be longer. On the contrary, when the drying temperature exceeds 130° C., there is a possibility in that the optical functional layer may be damaged. In order to proceed drying in a short period of time without heat damage, it is preferable that the drying time is in the range of 10 sec to 5 min, and more preferably in the range of 1 min to 2 min under the adequate temperature conditions.

A thickness t2 (μm) of the optical functional layer 3 can be controlled by adjusting application amount of the solution. In order to achieve high degree of transparency, desired excellent optical properties, and resistance to flaws, t2 is preferably in the range of 1 μm to 10 μm, and more preferably in the range of 2 μm to 5 μm. Here, the optical functional layer 3 having the thickness t2 of less than 1 μm may be too thin and therefore it is difficult to achieve desired optical properties or the like. On the contrary, when t2 exceeds 10 μm, t2 may be inadequate since the adhesive strength between the optical functional layer 3 and the base material 2 is low to cause increase in manufacturing cost. Note that the optical functional layer 3 may be composed of one layer or two or more layers. In a case where the optical functional layer 3 is composed of plural layers, the thickness in total is denoted by t2.

[Protective Material]

As shown in FIG. 1B, the protective material 4 contains a binder 11, fine particles 9 being formed of organic compound or inorganic compound, and a lubricant 10. The binder 11 used for the protective material 4 is a polymer whose glass transition temperature is 40° C. or more. The glass temperature is a temperature at which high-molecular material such as a polymer turns from a hard state like a glass to a soft state like a rubber upon being heated. The kind of polymer may be acrylic, polyurethane, polyester, or the like, and not especially limited. Thereby, the protective material 4 having excellent resistance to flaws can be obtained. In a case where the glass transition temperature is less than 40° C., it is difficult to keep sufficient resistance to flaws. Among the above polymers, one having carboxyl group in its molecules is especially preferable since it becomes possible to improve the adhesive strength between the protective material 4 and the base material 2. Further, as the binder 11, one kind of polymer may be used, or two or more kinds of polymer may be used as long as the predetermined glass transition temperature is satisfied. For example, when a polyurethane polymer having carboxyl group in its molecules and a polyester polymer is mixed to be used together, the protective material 4 having excellent resistance to flaws and high degree of adhesive strength can be obtained. Note that the molecular weight of the polymer is not especially limited, and in general, the polymer used as the binder can be adopted.

The materials of fine particles 9 being formed of organic compound or inorganic compound to be used for the protective material 4 are not especially limited. As organic fine particles, there are polystyrene, polymethylmethacrylate, silicone, and benzoguanamine, for example. As inorganic fine particles, there are silica, calcium carbonate, magnesium oxide, and magnesium carbonate, for example. Among them, polystyrene, polymethylmethacrylate, and silica are preferably used in view of excellent effect of improving lubricating properties and achieving low cost.

Regardless the material, an average diameter of the fine particles 9 is preferably in the range of 0.05 μm to 20 μm, and more preferably in the range of 0.5 μm to 15 μm. Thereby, the fine particles 9 aggregate, and it is possible to improve lubricating properties while keeping high degree of transparency. When the average diameter of the fine particles 9 is less than 0.05 μm, the effect of improving the lubricating properties is insufficient. On the contrary, when the average diameter of the fine particles 9 exceeds 20 μm, the fine particles 9 are inadequate since the degree of transparency and display quality may decrease. Further, although the additional amount of the fine particles 9 is varied depending on the average diameter of the fine particles 9, the additional amount thereof is preferably in the range of 0.1 mg/m² to 30 mg/m², and more preferably in the range of 0.5 mg/m² to 2 mg/m². When the additional amount of the fine particles 9 is less than 0.1 mg/m², the effect of improving the lubricating properties is low. On the contrary, when the additional amount of the fine particles 9 exceeds 3 mg/m², degree of transparency and display quality may decrease. The diameter of the fine particle 9 in the present invention is considered as a diameter of a circle having the same dimension as that of fine particle captured by a scanning electron microscope. The average diameter of the fine particles 9 is an average diameter of arbitrarily selected 50 fine particles.

Note that when the average diameter of the fine particles 9 is limited to one specified value, a large amount of fine particles having a large diameter must be used, and therefore the fine particles 9 tend to easily drop off from a film. Accordingly, it is preferable to use monodispersed fine particles each having a different average diameter. Further, when the average diameter of the fine particles is limited to one specified value, distribution of diameters of fine particles is wide, and therefore a large particles with a diameter twice or more larger than the average diameter tend to easily drop off from the film or damage contact surfaces or other optical components. In view of the above, it is preferable to use monodispersed fine particles each having the different average diameter. Note that it is preferable that the fine particles each having the different average diameter are gradually mixed to obtain the excellent lubricating properties.

Here, the monodispersed fine particles refer to particles having a monodispersibility obtained by the formula described below of less than 40%, more preferably less than 30%, and most preferably in the range of 0.1 to 20%.

“Monodispersibility=(standard deviation of particle diameter)/(average particle diameter)×100”

The lubricant 10 of the present invention is a substance for improving the lubricating properties between the multi-layer sheet 1 and the other materials when the lubricant 10 is added to the outermost layer (exposure layer) of the multi-layer sheet 1. The lubricant 10 is preferable at least one of dispersed synthetic wax or natural wax, silicone, and a compound represented by the below general formulae I, II, or III.

The wax is normally ester including higher fatty acid and higher alcohol. However, according to the present invention, in addition to the above, wax is comprehensive, that is, there are hydrocarbon, ketone, primary alcohol, secondary alcohol, terpenoid, and the like. The wax in the present invention includes synthetic wax and natural wax. As the synthetic wax, there are polyethylene wax, petroleum wax, fatty acid ester as monohydroxyl alcohol or polyalcohol, and fatty acid amide. As natural wax, there are candelilla wax, carnauba wax, beeswax, lanolin (adeps lanae), montan wax, and the like, for example.

The details about these wax is described in, for example, p. 40-44 in “The Handbook of Oil Chemistry-Lipids and Surfactants—(4th edition), edited by Japan Oil Chemist's Society, published by MARUZEN CO., LTD, 2001, or “Properties and Application of Wax (Revision), supervised by Kenzo Fusegawa, published by SAIWAISHOBO, 1988”. As wax used in the present invention, there are carnauba wax, paraffin wax, higher fatty acid wax, fatty acid amide wax, ester wax, and the like, for example. As preferable example of the wax of the present invention, there are Cellosol 524, 428, 732-B, 920, B-495, Hydrin P-7, D-757, Z-7-30, E-366, F-115, D-336, D-337, PolylonA, 393, H-481, Hi-micronG-110F, 930, G-270 (all manufactured by CHUKYO YUSHI. CO., LTD), Chemipearl W100, W200, W300, W400, W500, W950 (all manufactured by Mitsui Chemicals, Inc.), and the like.

The wax used in the present invention is preferably in a dispersed state and has an average diameter of approximately 20 nm to 5000 nm. The additional amount of the wax is preferably in the range of 0.1 mg/m² to 50 mg/m², and more preferably in the range of 1 mg/m² to 50 mg/m². When the additional amount of the wax is less than 0.1 mg/m², it is difficult to keep the lubricating properties. On the contrary, when the additional amount of the wax exceeds 50 mg/m², the surface defect may occur.

[Silicone]

Silicone serving as the lubricant in the present invention is a compound in which a main chain is a repeating unit having a siloxane bond and side chains are alkyl group and aryl group. Example is shown hereinbelow.

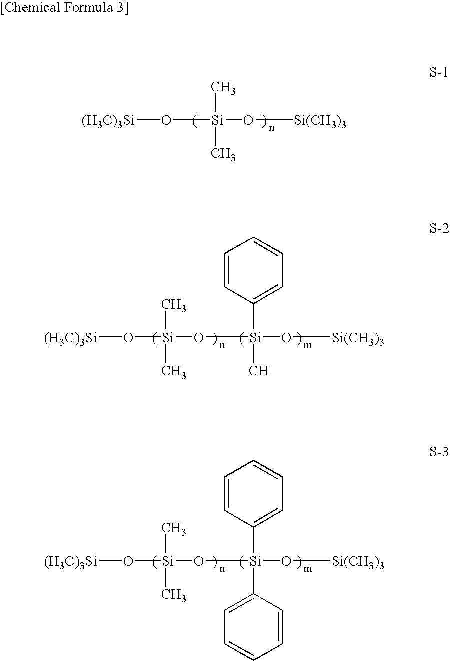

In the above chemical formula, n and m represent natural number in the range of 3 to 3000. Additionally, there is a denatured silicone oil in which alkyl group, amino group, carboxyl group, carbinol group, acrylic group, alkoxy group, fluorine-substituted alkyl group, higher fatty acid ester, and the like are bonded at the ends or side chains of the above compound. The denatured silicone oil is, for example, KF-412, 413, 414, 393, 859, 8002, 6001, 6002, 857, 410, 910, 851, X-22-162A, X-22-161A, X-22-162C, X-22-160AS, X-22-164B, X-22-164C, X-22-170B, X-22-800, X-22-819, X-22-820, X-22-821 (all manufactured by Shin-Etsu Chemical Co., Ltd.).

The silicone in the present invention is preferably used in a dispersed state whose average diameter is in the range of 20 nm to 5000 nm. The additional amount of the silicone is preferably in the range of 0.1 mg/m² to 50 mg/m², and more preferably in the range of 1 mg/m² to 2 mg/m². When the additional amount of the silicone is less than 0.1 mg/m², the lubricating properties may be insufficient. On the contrary, when the additional amount of the silicone exceeds 5 mg/m², the adhesion between adjacent layers may not be kept. Note that the average diameter of the wax and the silicone may be measured as in the case of the fine particles, and the description thereof is omitted here.

Next, a compound represented by the following general formulae I, II, or III is described. “R” denotes substituted or unsubstituted alkyl group, “n” denotes a natural number in the range of 3 to 20, and “M” denotes a monovalent metal atom. Further, “R” in the general formulae I to III is especially preferably linear alkyl group having carbon number of 10 to 30, and “M” is preferably natrium, kalium, and lithium.

[Chemical Formula 4]

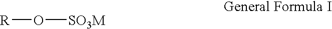

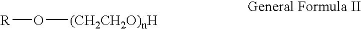

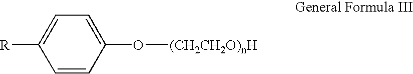

Concrete Example of the above compound is as follows.

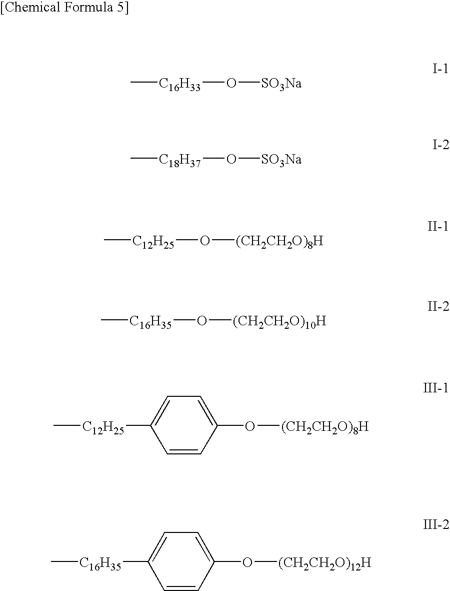

The additional amount of the above compound is preferably in the range of 0.1 mg/m² to 50 mg/m², and more preferably in the range of 1 mg/m² to 20 mg/m². When the additional amount of the wax is less than 0.1 mg/m², the lubricating properties may be insufficient. On the contrary, when the additional amount of the compound exceeds 50 mg/m², the surface defect may occur.

The protective material 4 of the present invention contains the binder 11 that is a polymer having a grass transition temperature of 40° C., the fine particles 9 being formed of organic compound or inorganic compound, and a lubricant 10 as its essential components. Additionally, as necessary, a cross-linking agent, a surfactant, and an antistatic agent may be added to the protective material 4.

The cross-linking agent may be epoxy, melamine, isocyanate, or carbodiimide cross-linking agent.

The surfactant may be a well-known anionic, nonionic, or cationic surfactant. The surfactant applicable to the present invention is described, for example, in “Handbook of Surfactants” (edited by Ichiro Nishi et al., published by Sangyo-Tosho, 1960).

As the antistatic agent, there are electron conductive polymers such as polyaniline and polypyrrole, ion conductive polymers having carboxyl group and sulfonate group in its molecular chain, conductive fine particles, and the like. Among them, in particular, the conductive fine particles of tin oxide described in Japanese Patent Laid-Open Publication No. 61-020033 may be preferably used in view of its conductivity and transparency.

The thickness t3 of the protective material 4 is preferably in the range of 0.02 μm to 20 μm, and more preferably in the range of 0.05 μm to 10 μm. When the thickness t3 is less than 0.02 μm, the adhesive strength between the protective material 4 and the adjacent layer may be insufficient. On the contrary, when the thickness t3 exceeds 20 μm, the surface defect may occur. Note that the protective material 4 may be composed of one layer or two or more layers. In a case where the protective material 4 is composed of plural layers, the thickness in total preferably satisfies the above range.

As shown in FIGS. 2A and 2B, the protective material 6 may include stacked two layers. The two layers are the fine-particle containing layer 7 containing a binder 14 that is a polymer having a glass transition temperature of 40° C. or more and fine particles 12 being formed of organic compound or inorganic compound, and the surface layer 8 containing the binder 15 and the lubricant 13. The surface layer 8 is formed on the fine-particle containing layer 7. Since the protective material 6 is separated into the fine-particle containing layer 7 and the surface layer 8, it is possible to further prevent the fine particles 12 from dropping off as compared to the protective material including only one layer.

The kind of polymer used as the binder 14 and the binder 15 of the protective materials 4 and 6 may be one, or two or more. For example, polyurethane, polyester, acrylic, and SBR can be used.

The application method of the protective material 4 is not especially limited. The application method may be a well-known method such as bar coater application and slide coater application. The solvent to be applied, that is mixed with the essential components and used, is not also especially limited, and aqueous solvent such as water, toluene, methanol, isopropyl alcohol, methyl ethyl ketone and mixture of them, or organic solvent may be used.

Although the application may be performed after the base material 2 is axially stretched or biaxially stretched, it is preferable that the application is performed after the biaxial stretching such that edge portions of the base material after the stretching in the width direction can be recovered.

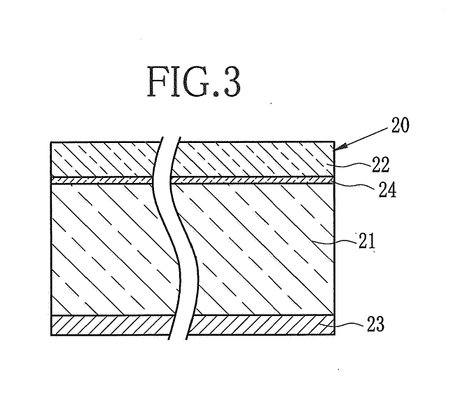

According to the present invention, a diffusion sheet 20 as shown in FIG. 3 can be readily formed. The diffusion sheet 20 includes a base material 21 formed of polyester, a light diffusion layer 22 formed on a first surface of the base material 21, and a protective material 23 formed on a second surface thereof such that the second layer is opposed to the first layer. A undercoat layer 24 is formed between the base material 21 and the light diffusion layer 22. It is preferable to provide the undercoat layer 24 since adhesion between the base material 21 and the light diffusion layer 22 can be increased with the intermediation of the undercoat layer 24. The thickness of each layer is set such that the range described in FIG. 1 is satisfied. The thickness of the light diffusion layer 22 together with the thickness of the undercoat layer 24 is denoted by t2.

The undercoat layer 24 includes a binder. The binder for the undercoat layer 24 is not especially limited, and a well-known polymer such as polyester, polyurethane, and polyacrylate may be used. Further, as necessary, epoxy, isocyanate, or carbodiimide cross-linking agent, anionic, nonionic, or cationic surfactant, and organic or inorganic matting agent may be contained in the undercoat layer 24. The formation method of the undercoat layer 24 is not especially limited. For example, a mixture including materials for forming the undercoat layer 24 and aqueous solvent or inorganic solvent is applied to the base material 21 by the well-known application method and dried. Thereby, it is possible to form readily the undercoat layer 24.

The light diffusion layer 22 contains the binder and the fine particles. For achieving resistance to flaws in handling, resistance to solvent for the purpose of wiping dust adhered to the surface, and adhesion between the light diffusion layer 22 and the base material 21 when punching process in which the diffusion sheet 20 is punched into the predetermined shape is performed in some cases, it is preferable to contain the cross-linking agent in the light diffusion layer 22. Note that the light diffusion layer 22 is composed of one layer or two or more layers as needed. In a case where the light diffusion layer 22 is composed of plural layers, it is not necessary that each layer has the same optical function, and the optical functions may be arbitrarily selected.

The binder to be used for the light diffusion layer 22 is not especially limited, and selectively used in accordance with the purpose. The preferable example of the binder is a well-known polymer such as acrylic, polyester, or polyurethane binder. Among them, homopolymer or copolymer containing at least one of acrylic acid ester and methacrylic acid ester as a component of monomer is preferably used to keep excellent optical properties and high degree of transparency.

As the above homopolymer or copolymer, there are poly(meth)acrylate, polyvinyl acetate, ethylene-vinyl acetate copolymer, polyvinyl chloride, vinyl chloride-vinylidene chloride copolymer, butyral resin, silicone, polyester, polyvinylidene fluoride, nitrocellulose polymer, polystyrene, styrene-acrylonitrile copolymer, urethane, polyethylene, polypropylene, chlorinated polyethylene, and resin derivative, for example. One kind of homopolymer or copolymer may be used, or two or more kinds of homopolymer or copolymer may be used. Among them, poly(meth)acrylate is especially preferable since there is little possibility that organic particles are dissolved or swelled. Further, the polymer capable of reacting with the above cross-linking agent is preferably used. For example, in a case where the cross-linking agent is isocyanate cross-linking agent, a polymer having hydroxyl, amino group, carboxyl group and the like may be used. Note that one kind of binder may be used, or two or more kinds of binder may be used.

The fine particles serving as a light diffusing agent for diffusing transmitted light are contained in the light diffusion layer 22. The fine particles are not especially limited, and may be selectively used in accordance with the purpose. Preferable examples are organic particles such as polymethylmethacrylate particle, melamine particle, and polystyrene particle, and silicone particle. One kind of particle may be used, or two or more kinds of particles may be used. The organic particles preferably have a cross-linking structure. In particular, polymethylmethacrylate particles having the cross-linking structure are preferable.

The average diameter of the fine particles is preferably in the range of 5 μm to 100 μm, and more preferably in the range of 10 μm to 25 μm. When the average diameter of the particles is less than 5 μm, light diffusion properties may be insufficient. On the contrary, when the average diameter of the particles exceeds 100 μm, the transmission of light may be prevented due to too large size of the particles, and in addition to this, it may be difficult to achieve the light diffusion properties. Further, a sedimentation speed of the fine particles becomes fast in a coating liquid, sedimentation of the fine particles occur in pipes to be used for sending liquid and a buffer tank. Note that since the method for obtaining the average diameter of the particles is the same as that of the above, the description thereof is omitted.

The additional amount of the fine particles is preferably in the range of 100 parts by mass to 500 parts by mass relative to 100 parts by mass of binder, and more preferably in the range of 200 parts by mass to 400 parts by mass relative to 100 parts by mass of binder. When the additional amount of the fine particles is less than 100 parts by mass, it may be difficult to achieve the light diffusion properties. On the contrary, when the additional amount of the fine particles exceeds 500 parts by mass, the fine particles may have difficulty in diffusing. Further, in the present invention, in addition to the above fine particles, other kinds of fine particles may be used. For example, it is preferable that silica, calcium carbonate, alumina, and zirconia each having an average diameter of 1 μm to 5 μm is used together with polymethylmethacrylate particles having an average diameter of 10 μm to 25 μm. The additional amount of the fine particles to be used together is preferably in the range of 1 mass % to 20 mass % of the fine particles as main component.

It is preferable that the cross-linking agent is contained in the light diffusion layer 22 in order to achieve resistance to solvent and adhesion between the light diffusion layer 22 and the base material 21. The cross-linking agent may be epoxy, isocyanate, melamine, oxazoline, carbodiimide, and the like. Among them, isocyanate cross-linking agent is preferably used. The amount of the cross-linking agent contained in the light diffusion layer 22 is preferably 10 parts by mass or more relative to 100 parts by mass of binder, and more preferably in the range of 30 parts by mass to 400 parts by mass relative to 100 parts by mass of binder. When the amount of the cross-linking agent contained in the light diffusion layer 22 is less than 10 parts by mass, the light diffusion layer 22 may be easily damaged. Further, when the mass of the cross-linking agent is denoted by “a” and the mass of binder is denoted by “b”, mass ratio of the cross-linking agent to the binder in the light diffusion layer 22 “a/b” is preferably in the range of 10 to 20, more preferably in the range of 3 to 15, and most preferably in the range of 5 to 10.

When the light diffusion layer 22 is formed, the solvent to be mixed with the materials such as the binder is not especially limited. The preferable solvents are (a) ketone, (b) ether, (c) alcohol, (d) ester, (e) polyhydric alcohol derivatives, and (f) carboxylic acid. Preferable examples thereof are hereinafter described in a state attached with specific gravity (g/cm³). The specific gravity is the ratio of a material to water having the same volume as that of the material. Here, the specific gravity in parenthesis is attached to the name of each compound, and the description of the unit is omitted.

As (a) ketone, there are acetylacetone (0.975), cyclohexanone (0.945), methylcyclohexanone (0.921), acetone (0.791), diethyl ketone (0.816), methyl ethyl ketone (0.805), methyl-n-butyl ketone (0.821), methyl-n-propyl ketone (0.806), and the like, for example.

As (b) ether, there are 1,4-dioxane (1.039), and tetrahydrofuran (0.889), and the like, for example.

As (c) alcohol, there are cyclohexanol (0.949), 3-pentanol (1.046), 2-methylcyclohexanol (0.925), isopropyl alcohol (0.785), ethanol (0.791), n-butanol (0.810), t-butanol (0.787), 1-propanol (0.804), methanol (0.792), and the like, for example.

As (d) ester, there are isoamyl formate (0.877), isobutyl formate (0.885), ethyl formate (0.917), butyl formate (0.892), propyl formate (0.901), hexyl formate (0.990), benzyl formate (1.081), methyl formate (0.987), allyl acetate (0.927), isoamyl acetate (0.871), isobutyl acetate (0.873), isopropyl acetate (0.877), ethyl acetate (0.901), 2-ethylhexyl acetate (0.872), cyclohexyl acetate (0.97), n-butyl acetate (0.876), s-butyl acetate (0.875), propyl acetate (0.887), methyl acetate (0.934), ethyl propionate (0.896), butyl propionate (0.877), methyl propionate (0.916), and the like, for example.

As (e) polyhydric alcohol derivatives, there are ethylene glycol monoethyl ether acetate (0.975), ethylene glycol monomethyl ether (0.964), ethylene glycol monomethyl ether acetate (1.009), ethylene glycol monomethoxymethyl ether (1.04), propylene glycol monoethyl ether (0.898), propylene glycol monomethyl ether (0.923), and the like, for example.

As (f) carboxylic acid, there are isobutyric acid (0.948), capric acid (1.049), and the like, for example.

Among them, in view of being dried easily after application, an organic solvent having the boiling point of 150° C. is preferable, and methyl ethyl ketone, cyclohexanone, 1,4-dioxane, and ethylene glycol monomethyl ether acetate are especially preferable.

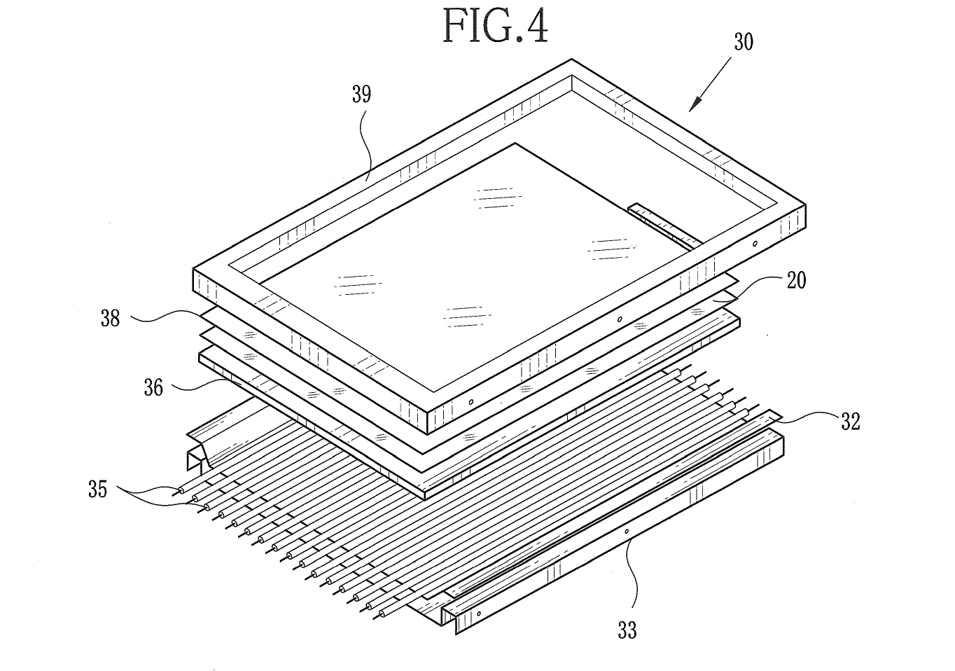

The diffusion sheet 20 described above can be preferably used as main component of a backlight unit 30 constituting the LCD. FIG. 4 is a schematic perspective view of the backlight unit 30 commonly used. Note that, for the purpose of preventing complication of the drawing, only main components are shown, however in actual, the backlight unit 30 includes other plural components. Hereinafter, the components constituting the backlight unit 30 are described. A reflection sheet 32 is adhered inside a rear frame 33. Plural lamps 35 are provided inside the rear frame 33. The plural lamps 35 are a light source for illuminating the liquid crystal cells. A diffusion plate 36 is provided on the lamps 35. Further, a diffusion sheet 20 and a prism sheet 38 are provided on the diffusion plate 36 in this order. The components are sandwiched between the rear flame 33 and a front frame 39 to be fixed thereto. The diffusion sheet 20 of the present invention has an excellent light diffusion properties and excellent resistance to flaws on the surface of the base material at the side opposed to the light diffusion layer 22. Therefore, it is possible to provide an image with high definition without deterioration of contrast and brightness unevenness.

### EXAMPLE

Hereinafter, in order to explain the present invention in detail, Experiments 1 to 9 were performed as examples. However, the present invention is not limited thereto. Note that Experiments 1 to 5 are examples of the present invention, and Experiments 6 to 9 are comparative examples thereof.

### Experiment 1

In experiment 1, an undercoat layer was formed on a first surface of the base material 2 formed of polyester, and the protective material 4 was formed on a second surface of the base material 2 such that the protective material 4 was opposed to the undercoat layer. Thus, the multi-layer sheet 1 was produced.

[Base Material]

Polyethylene terephthalate (hereinafter referred to as PET) having an inherent viscosity of 0.66 was prepared. The PET was obtained by polycondensation reaction using Ge as a catalyst. After being dried until the water content thereof became 50 ppm or less, the PET was melted inside an extruder having a heater with a temperature adjusted to approximately a constant level within a range of 280° C. to 300° C. Next, the melted PET was discharged from a die onto a chill roll subjected to electrostatic application, to obtain an amorphous film. Thereafter, the amorphous film was stretched in a transporting direction of the film by 3.1 times, and then stretched in a width direction of the film by 3.9 times, thus obtaining the base material 2 having a thickness of 188 μm.

[Undercoat Layer]

While the above base material 2 was transported at the transporting speed of 70 m/min, the surface of the base material 2 was subjected to corona discharge treatment under the condition of 727 J/m². Then, a coating liquid having the following composition was applied to the subjected surface of the base material 2 by the bar coat method to form the undercoat layer. The application amount of the coating liquid was 4.4 cm³/m², and the drying was performed at 180° C. for 1 minute.

[Coating liquid for undercoat layer]

| | |
|---|---|
| binder (polyester, produced by Dainippon Ink & | 44.9 parts by mass |
| Chemicals, Inc., Finetex ES-650, | |
| solid content of 29% | |
| cross-linking agent (Carbodilite V-02-L2, | 1.3 parts by mass |
| produced by Nisshinbo Industries, Inc.) | |
| silica fine particles (Aerosil OX-50, produced | 1.4 parts by mass |
| by NIPPON AEROSIL CO., LTD., | |
| solid content of 10%) | |
| lubricant (Cellosol 524, produced by CHUKYO | 8.5 parts by mass |
| YUSHI CO., LTD., solid content of 3%) | |
| surfactant 1 (Rapisol B-90, produced by NOF | 1.2 parts by mass |
| CORPORATION., anionic) | |
| surfactant 2 (Naloacty HN-100, produced by | 0.1 parts by mass |
| Sanyo Chemical Industries, Ltd., nonionic) | |

Distilled water was added to a liquid in which the above materials were mixed together such that the total amount became 1000 parts by mass in order to prepare a coating liquid for the undercoat layer.

[Protective Material]

Next, while the base material 2 was transported at the transporting speed of 70 m/min, the second surface of the base material 2, which was opposed to the side of the undercoat layer, was subjected to the corona discharge treatment under the condition of 727 J/m². After a coating liquid having the following composition was applied to the subjected surface of the base material 2 by the bar coat method such that the application amount of the coating liquid was 13.8 cm³/m², the drying was performed at 180° C. for 1 minute to form the protective material 4 having a thickness t3 of 2 μm. Thereby, the multi-layer sheet 1 was obtained.

[Coating liquid for protective material]

| | |
|---|---|
| binder (polyurethane, produced by Dainippon Ink & | 659 parts by mass |
| Chemicals, Inc., Hydran AP-40F, solid content | |
| of 22%, glass transition temperature of 50° C.) | |
| cross-linking agent (Carbodilite V-02-L2, | 36.3 parts by mass |
| produced by Nisshinbo Industries, Inc., | |
| solid content of 40%) | |
| cross-linked polymethyl methacrylate (PMMA) fine | 1.5 parts by mass |
| particles (MX-300, produced by Soken | |
| Chemical & Engineering Co., Ltd., average | |
| diameter of particles of 3 μm) | |
| lubricant (Cellosol 524, produced by CHUKYO | 7.3 parts by mass |
| YUSHI CO., LTD., solid content of 30%) | |
| surfactant 1 (Rapisol B-90, produced by NOF | 1.0 parts by mass |
| CORPORATION., anionic) | |
| surfactant 2 (Naloacty HN-100, produced by | 1.0 parts by mass |
| Sanyo Chemical Industries, Ltd., nonionic) | |

Distilled water was added to a liquid in which the above materials were mixed together such that the total amount became 1000 parts by mass in order to prepare a coating liquid for the protective material.

Haze and resistance to flaws of the protective material 4 in the produced multi-layer sheet 1 were measured by the following measurement. Further, the glass transition temperature of the binder 11 used for the protective material 4 was measured.

[Haze Measurement]

By use of a haze meter (NDH-1001P, produced by Nippon Denshoku Industries Co., Ltd.), haze as index of light diffusion properties of the produced multi-layer film was measured based on a method of JIS-K-6714-1977.

[Resistance to Flaws of Protective Material]

The humidity of the produced multi-layer sheet 1 was controlled at the temperature of 25° C. and under the atmosphere of 60% RH for 24 hours. The resultant multi-layer sheet 1 was taken as a sample. Scratch resistance of the sample was measured by the following method. First of all, the surface of the protective material 4 as the sample was scratched by a sapphire stylus of 0.5 mmR at a speed of 1 cm/sec while changing the load applied thereto between 0 to 100 g. At this time, the existence of the scratches on the surface was examined, and the load at which scratch was firstly observed was considered as the minimum load. The minimum load was set as an index of the scratch resistance. At this time, as the extent of scratch resistance, a level satisfying a product level was denoted by P (Passed), and a level not satisfying a product level was denoted by F (False).

[Glass Transition Temperature]

The glass transition temperature of the dried binder 11 for the protective material 4 was measured by a DSC (Q-1000, produced by TA Instrument CO., LTD) at the rate of temperature rise of 5° C./min.

### Experiment 2

In Experiment 2, the binder 11 for the protective material 4 was a polyester different from that in Experiment 1 (Plus coat Z687, produced by GOO CHEMICAL CO., LTD, solid content of 25%, glass transition temperature of 110° C.). Other conditions for producing the multi-layer sheet 1 were the same as those in Experiment 1.

### Experimenet 3

In Experiment 3, the protective material 4 was formed under the following conditions. Other conditions for producing the multi-layer sheet 1 were the same as those in Experiment 1.

[Coating liquid for protective material]

| | |
|---|---|
| monomer (Dipentaerythritol Hexaacrylate) | 145 parts by mass |
| polymerization initiator | 4.4 parts by mass |
| (2,4-bis(trichloromethyl)-6-(4-N,N- | |
| diethoxycarbonylmethyl)-3-bromophenyl)-s-triazine) | |
| benzoguanamine fine particles (Epostar-M-30, | 1.5 parts by mass |
| produced by NIPPON SHOKUBAI CO., LTD., | |
| average diameter of 3 μm) | |
| lubricant (KF-412 produced by Shin-Etsu Chemical | 7.3 parts by mass |
| Co., LTD.) | |
| surfactant (F780F, produced by Dainippon Ink & | 1.0 parts by mass |
| Chemicals, Inc., solution containing 30 parts by | |
| mass of methyl ethyl ketone) | |

Methyl ethyl ketone was added to a liquid in which the above materials were mixed together such that the total amount became 1000 parts by mass in order to prepare a coating liquid for the protective material.

After the base material 2 as the same as that in Experiment 1 was formed, the above coating liquid was applied to the second surface of the base material 2, which was opposed to the side of the undercoat layer, by the bar coat method. The resultant base material 2 was dried at the temperature of 100° C. for 1 minute. Thereafter, the entire surface was exposed at the intensity of 500 mJ/m² by an extra high pressure mercury lamp to harden layer. Thereby, the protective material 4 was obtained. Application was performed such that the application amount of the coating liquid for the protective material was 13.88 cm³/m².

Note that in Experiment 3, when the glass transition temperature of the binder 11 was measured, a protective material 4 formed of only the polymerization initiator and the solvent was used as a sample. The measurement was performed as in the case of Experiment 1.

### Experiment 4

In Experiment 4, the following coating liquid for the protective material was formed. The other conditions for producing the multi-layer sheet 1 were the same as those in Experiment 1.

[Coating liquid for protective material]

| | |
|---|---|
| binder (polyurethane, produced by Dainippon Ink & | 659 parts by mass |
| Chemicals, Inc., Hydran AP-40F, | |
| solid content of 22%) | |
| cross-linking agent (Carbodilite V-02-L2, produced | 36.3 parts by mass |
| by Nisshinbo Industries, Inc., | |
| solid content of 40%) | |
| slicone fine particles (Tospearl 120, produced by | 1.5 parts by mass |
| Momentive Performance Materials Holdings Inc., | |
| average diameter of particles of 2 μm) | |
| lubricant (Cellosol 524, produced by CHUKYO | 7.3 parts by mass |
| YUSHI CO., LTD., solid content of 30%) | |
| surfactant 1 (Rapisol B-90, produced by NOF | 1.0 parts by mass |
| CORPORATION., anionic) | |
| surfactant 2 (Naloacty HN-100, produced by | 1.0 parts by mass |
| Sanyo Chemical Industries, Ltd., nonionic) | |

Distilled water was added to a liquid in which the above materials were mixed together such that the total amount became 1000 parts by mass in order to prepare a coating liquid for the protective material.

### Experiment 5

In Experiment 5, an undercoat layer 1 was formed on a first surface of the base material 21 formed of polyester and an undercoat layer 2 was formed on the undercoat layer 1. Further, the protective material 6 separated into the fine particle-containing layer 7 and a surface layer 8 was formed on a second surface of the base material 21, which was opposed to the side of the undercoat layers 1 and 2. The other conditions for producing the multi-layer sheet 5 were the same as those in Experiment 1.

[Undercoat Layer 1]

While the above base material 21 was transported at the transporting speed of 70 m/min, the surface of the base material 21 was subjected to corona discharge treatment under the condition of 727 J/m². Then, a coating liquid having the following composition was applied to the subjected surface of the base material 21 by the bar coat method to form the undercoat layer. The application amount of the coating liquid was 7.1 cm³/m², and the drying was performed at 180° C. for 1 minute.

[Coating liquid for undercoat layer 1]

| | |
|---|---|
| polyester binder (Plus coat Z687, produced by | 118 parts by mass |
| GOO CHEMICAL CO., LTD, solid content of 25%, | |
| glass transition temperature of 110° C.) | |
| cross-linking agent (Carbodilite V-02-L2, produced | 14.5 parts by mass |
| by Nisshinbo Industries, Inc., | |
| solid content of 40%) | |
| surfactant 1 (Rapisol B-90, produced by NOF | 0.1 parts by mass |
| CORPORATION., anionic) | |
| surfactant 2 (Naloacty CL-95, produced by Sanyo | 0.24 parts by mass |
| Chemical Industries, Ltd., nonionic) | |
| distilled water added such that the total amount | 1000 parts by mass |
| became | |

[Undercoat Layer 2]

While the base material 21 to which the above undercoat layer 1 was formed was transported at the transporting speed of 70 m/min, the surface of the undercoat layer 1 was subjected to corona discharge treatment under the condition of 727 J/m². Then, a coating liquid having the following composition was applied to the subjected surface of the base material 21 by the bar coat method to form the undercoat layer 2. The application amount of the coating liquid was 7.1 cm³/m², and the drying was performed at 150° C. for 1 minute.

[Coating liquid for undercoat layer 2]

| | |
|---|---|
| polyurethane binder (Olestar UD350, produced by | 24.3 parts by mass |
| Mitsui Chemicals, Inc., solid content of 38%) | |
| cross-linking agent (Carbodilite V-02-L2, produced | 4.6 parts by mass |
| by Nisshinbo Industries, Inc., | |
| solid content of 40%) | |
| additive (filler) (Aerosil OX-50, produced by | 0.15 parts by mass |
| NIPPON AEROSIL CO., LTD., | |
| solid content of 10%) | |
| additive (filler) (Snowtex XL, produced by | 0.39 parts by mass |
| Nissan Chemical Industries, Ltd, | |
| solid content of 40%) | |
| additive (lubricant) (Cellosol 524, produced by | 0.16 parts by mass |
| CHUKYO YUSHI CO., LTD., solid content | |
| of 30%) | |
| surfactant 1 (Rapisol B-90, produced by NOF | 0.12 parts by mass |
| CORPORATION., anionic) | |
| surfactant 2 (Naloacty CL-95, produced by Sanyo | 0.15 parts by mass |
| Chemical Industries, Ltd., nonionic) | |
| distilled water added such that the total amount | 1000 parts by mass |
| became | |

[Fine Particle-Containing Layer]

While the above base material 21 was transported at the transporting speed of 70 m/min, the surface of the base material 21, which was opposed to the side of the undercoat layers, was subjected to corona discharge treatment under the condition of 727 J/m². Then, after a coating liquid having the following composition was applied to the subjected surface by the bar coat method such that the application amount of the coating liquid was 9.9 cm³/m², and the drying was performed at 180° C. for 1 minute. Thereby, the fine particle-containing layer as a first layer of the protective material 6 having a thickness of 0.3 μm.

[Coating liquid for fine particle-containing layer]

| | |
|---|---|
| polyester binder (Plus coat Z687, produced by | 118 parts by mass |
| GOO CHEMICAL CO., LTD, solid content of 25%, | |
| glass transition temperature of 110° C.) | |
| cross-linking agent (Carbodilite V-02-L2, produced | 14.5 parts by mass |
| by Nisshinbo Industries, Inc., | |
| solid content of 40%) | |
| acrylic fine particles (MX-501, produced by | 0.54 parts by mass |
| Soken Chemical & Engineering Co., Ltd., | |
| average diameter of particles of 5.4 μm, | |
| CV value of 9.0) | |
| Dispersion liquid containing polystyrene fine | 2.7 parts by mass |
| particles (UNF1008, produced by ZEON | |
| CORPORATION, average diameter of | |
| particles of 1.8 μm, solid content of 20%) | |
| surfactant 1 (Rapisol B-90, produced by NOF | 0.1 parts by mass |
| CORPORATION., anionic) | |
| surfactant 2 (Naloacty CL-95, produced by | 0.24 parts by mass |
| Sanyo Chemical Industries, Ltd., nonionic) | |
| Distilled water added such that the total amount | 1000 parts by mass |
| became | |

[Surface Layer]

Next, while the above base material 21 was transported at the transporting speed of 70 m/min, the surface of the base material 21, which was opposed to the side of the undercoat layer, was subjected to corona discharge treatment under the condition of 727 J/m². Then, after a coating liquid having the following composition was applied to the subjected surface of the base material 21 by the bar coat method such that the application amount of the coating liquid was 9.9 cm³/m², and the drying was performed at 180° C. for 1 minute. Thereby, the surface layer 8 as a second layer of the protective material 6 having a thickness of 0.1 μm was formed, thus obtaining the multi-layer sheet 5.

[Coating liquid for surface layer]

| | |
|---|---|
| polyurethane binder (Olestar UD350, produced by | 24.3 parts by mass |
| Mitsui Chemicals, Inc., solid content of 38%) | |
| cross-linking agent (Carbodilite V-02-L2, produced | 4.6 parts by mass |
| by Nisshinbo Industries, Inc., solid content | |
| of 40%) | |
| additive (filler) (Aerosil OX-50, produced by | 0.15 parts by mass |
| NIPPON AEROSIL CO., LTD., | |
| solid content of 10%) | |
| additive (filler) (Snowtex XL, produced by | 0.39 parts by mass |
| Nissan Chemical Industries, Ltd, | |
| solid content of 40%) | |
| additive (lubricant) (Cellosol 524, produced by | 0.5 parts by mass |
| CHUKYO YUSHI CO., LTD., solid content | |
| of 30%) | |
| surfactant 1 (Rapisol B-90, produced by | 0.12 parts by mass |
| NOF CORPORATION., anionic) | |
| surfactant 2 (Naloacty CL-95, produced by Sanyo | 0.15 parts by mass |
| Chemical Industries, Ltd., nonionic) | |
| distilled water added such that the total amount | 1000 parts by mass |
| became | |

### Experiment 6

In Experiment 6, the following coating liquid for the protective material was formed. The other conditions for producing a multi-layer sheet were the same as those in Experiment 1.

[Coating liquid for protective material]

| | |
|---|---|
| binder (polyester, produced by Dainippon Ink | 659 parts by mass |
| & Chemicals, Inc., Hydran AP-40F, | |
| solid content of 22%) | |
| cross-linking agent (Carbodilite V-02-L2, produced | 36.3 parts by mass |
| by Nisshinbo Industries, Inc., solid content | |
| of 40%) | |
| surfactant 1 (Rapisol B-90, produced by NOF | 1.0 parts by mass |
| CORPORATION., anionic) | |
| surfactant 2 (Naloacty HN-100, produced by Sanyo | 1.0 parts by mass |
| Chemical Industries, Ltd., nonionic) | |

Distilled water was added to a liquid in which the above materials were mixed together such that the total amount became 1000 parts by mass in order to prepare a coating liquid for the protective material.

### Experiment 7

In Experiment 7, the following coating liquid for the protective material was used. The other conditions for producing a multi-layer sheet were the same as those in Experiment 1.

[Coating liquid for protective material]

| | |
|---|---|
| binder (polyester, produced by Dainippon Ink | 659 parts by mass |
| & Chemicals, Inc., Hydran AP40F, solid | |
| content of 22%) | |
| cross-linking agent (Carbodilite V-02-L2, produced | 36.3 parts by mass |
| by Nisshinbo Industries, Inc., solid content | |
| of 40%) | |
| cross-linked PMMA fine particles (MX-300, | 1.5 parts by mass |
| produced by Soken Chemical & Engineering | |
| Co., Ltd., average diameter of particles of 3 μm) | |
| surfactant 1 (Rapisol B-90, produced by NOF | 1.0 parts by mass |
| CORPORATION., anionic) | |
| surfactant 2 (Naloacty HN-100, produced by | 1.0 parts by mass |
| Sanyo Chemical Industries, Ltd., nonionic) | |

Distilled water was added to a liquid in which the above materials were mixed together such that the total amount became 1000 parts by mass in order to prepare a coating liquid for the protective material.

### Experiment 8

In Experiment 8, as the binder for the protective material, polyester binder (produced by Dainippon Ink & Chemicals, Inc., Finetex ES-650, solid content of 29%, glass transition temperature of 30° C.) was used. The other conditions for producing a multi-layer sheet were the same as those in Experiment 1.

### Experiment 9

In Experiment 9, the following coating liquid for the protective material was used. The other conditions for producing a multi-layer sheet were the same as those in Experiment 1. Note that when the protective material is formed, as in the case of Experiment 1, while the base material provided with the undercoat layer was transported at the transporting speed of 70 m/min, the surface of the base material, which was opposed to the side of the undercoat layer, was subjected to the corona discharge treatment under the condition of 727 J/m². After a coating liquid having the following composition was applied to the subjected surface of the base material by the bar coat method such that the application amount of the coating liquid was 13.8 cm³/m², the drying was performed at 180° C. for 1 minute to form the protective material having a thickness of 2 μm after drying. Thereby, the multi-layer sheet was obtained.

[Coating liquid for protective material]

| | |
|---|---|
| binder (polyester, produced by Dainippon Ink | 500 parts by mass |
| & Chemicals, Inc., Finetex ES-650, solid | |
| content of 29%, glass transition temperature | |
| of 30° C.) | |
| cross-linking agent (Carbodilite V-02-L2, produced | 36.3 parts by mass |
| by Nisshinbo Industries, Inc., solid content | |
| of 40%) | |
| cross-linked PMMA fine particles (MX-300, | 1.5 parts by mass |
| produced by Soken Chemical & Engineering | |
| Co., Ltd., average diameter of particles of 3 μm) | |
| surfactant 1 (Rapisol B-90, produced by NOF | 1.0 parts by mass |
| CORPORATION., anionic) | |
| surfactant 2 (Naloacty HN-100, produced by | 1.0 parts by mass |
| Sanyo Chemical Industries, Ltd., nonionic) | |

Distilled water was added to a liquid in which the above materials were mixed together such that the total amount became 1000 parts by mass in order to prepare a coating liquid for the protective material.

Main production conditions and each evaluation result in each Experiment are shown in FIG. 1.

TABLE 1

| | protective material | | | | | |
|---|---|---|---|---|---|---|
| | Glass | | | | | |
| | transition | | | | Minimum | |
| | temperature | Fine | Lubri- | Haze | load | Scratch |
| | (° C.) | particles | cant | (%) | (%) | resistance |
| Ex. 1 | 50 | A-1 | B-1 | 0.85 | 56 | P |
| Ex. 2 | 110 | A-1 | B-1 | 0.82 | 68 | P |
| Ex. 3 | 130 or more | A-2 | B-2 | 0.79 | 55 | P |
| Ex. 4 | 50 | A-3 | B-1 | 0.85 | 89 | P |
| Ex. 5 | 110 | A-4, A-5 | B-1 | 3.5 | 89 | P |
| Ex. 6 | 50 | None | None | 0.88 | 23 | F |
| Ex. 7 | 50 | A-1 | None | 0.81 | 29 | F |
| Ex. 8 | 30 | A-1 | B-1 | 0.78 | 21 | F |
| Ex. 9 | 50 | A-1 | None | 0.76 | 18 | F |

Note that symbols in Table 1 are as follows.
A-1: MX-300 (produced by Soken Chemical & Engineering Co., Ltd., cross-linked PMMA fine particles)
A-2: Epostar-M-30 (produced by NIPPON SHOKUBAI CO., LTD., benzoguanamine fine particles)
A-3: Tospearl 120 (produced by Momentive Performance Materials Inc., slicone fine particles)
A-4: MX-501 (produced by Soken Chemical & Engineering Co., Ltd., cross-linked PMMA fine particles)
A-5: UNF1008 (produced by ZEON CORPORATION, polystyrene fine particles)
B-1: Cellosol 524 (produced by CHUKYO YUSHI CO., LTD., carnauba wax, solid content of 30%)
B-2: KF-412 (produced by Shin-Etsu Chemical Co., Ltd., denatured silicone oil)

According to the above results, the multi-layer sheets obtained in Experiments 1 to 9 each had high extent of transparency. Additionally, when the minimum load as the index of scratch resistance was measured, due to the high minimum load, each scratch resistance exhibited high value in Experiments 1 to 5. On the contrary, due to small minimum load, each scratch resistance exhibited small value in Experiments 6 to 9.

The following coating liquid was applied to the undercoat layer of the multi-layer sheet in each Experiment 1 to 5, which exhibited excellent evaluation results, to form the light diffusion layer. Thereby, the diffusion sheet as shown in FIG. 3 was obtained. Then, the extent of light diffusion and brightness of each diffusion sheet as a sample were measured by a method described later. Thereby, the optical properties were evaluated.

[Light Diffusion Layer]

A coating liquid for light diffusion layer and a crosslinking agent liquid each having the following composition was transported by a pump such that flow rate of the coating liquid for light diffusion layer was 100 g and the flow rate of the crosslinking agent liquid was 9.98 g. During the transportation, they were mixed by a static mixer (φ 3.4-N60S-523-F, manufactured by Noritake Co., Limited). Then, 3 minutes after the formation of the mixture, the mixture was applied to the surface of the multi-layer sheet at the side of the undercoat layer such that the application amount thereof was 64.4 cm³/m². Thereafter, the surface was dried at 120° C. for 2 minutes to form the light diffusion layer.

[Coating liquid for light diffusion layer]

| | |
|---|---|
| methyl ethyl ketone | 1.130 g |
| polyacrylate (Acrydic A811BE, produced by Dainippon Ink | 501.6 g |
| & Chemicals, Inc.,) 50 parts by mass of solution (hydroxyl value | |
| of 15, acid value of 3) | |
| Jurymer MB-20X (organic spherical fine particles of | 421.3 g |
| crosslinked polymethylmethacrylate, produced by NihonJunyaku | |
| Co., Ltd., average diameter of particles of 18 μm) | |
| F780F (produced by Dainippon Ink & Chemicals, Inc., | 0.97 g |
| solution containing 30 parts by mass of methyl ethyl ketone) | |

[crosslinking agent liquid]

| | |
|---|---|
| methyl ethyl ketone | 1039 g |
| isocyanate compound (Takenate D110N, produced by MITSUI | 352 g |
| CHEMICALS POLYURETHANES, INC.) | |

[Measurement of Light Diffusion Properties]

Haze value (%) at a light source C was measured by a Haze meter (produced by SUGA TEST INSTRUMENTS Co., Ltd.). Note that as the haze value is higher, the light diffusion properties are more excellent.

[Evaluation of Increasing Rate of Brightness from Front Side]

A direct backlight unit for the LCD shown in FIG. 4 was used as the light source. The above light diffusion sheet was disposed on the diffusion plate of the backlight unit, and the brightness (K₁) from front side was measured by a brightness photometer (BM-7, produced by TOPCOM CORPORATION). Further, in the same manner, the brightness (K₀) from front side without the diffusion plate was measured and obtained K₁/K₀ as the increasing rate of brightness from front side. Note that lamps 35 shown in FIG. 4 were cold-cathode tubes.

According to the above evaluation results, haze values of the diffusion sheet of the multi-layer sheet in Experiments 1 to 5 were 89.3%, 89.1%, 89.2%, 88.9%, and 89.7%, in order, thus exhibiting excellent light diffusion properties. Further, increasing rate of brightness from front side in Experiments 1 to 5 was 1.32, 1.31, 1.31, 1.31, 1.34, in order. Each increasing rate of brightness from front side was at a level for providing high dissolution. As a result, it can be confirmed that, when an optical functional layer such as a diffusion layer is formed on a surface of a base material at the side opposed to a protective material containing predetermined components, it is possible to obtain an optical sheet having high degree of transparency and resistance to flaws.

The present invention is not to be limited to the above embodiments, and on the contrary, various modifications will be possible without departing from the scope and spirit of the present invention as specified in claims appended hereto.

1. An optical multi-layer sheet comprising:
a base material formed of polyester;
an optical functional layer formed on a first surface of said base material; and
a protective material formed on a second surface of said base material, said protective material including fine particles, a lubricant, and a binder, said fine particles being formed of organic compound or inorganic compound, and said binder being a polymer having a glass transition temperature of 40° C. or more.

2. An optical multi-layer sheet as defined in claim 1, wherein said base material is biaxially stretched in advance.

3. An optical multi-layer sheet as defined in claim 1, wherein said lubricant is at least any one of wax, a silicone, and a compound represented by any one of the following General Formulae I, II, and III shown in Chemical Formula 1,
[Chemical Formula 1] 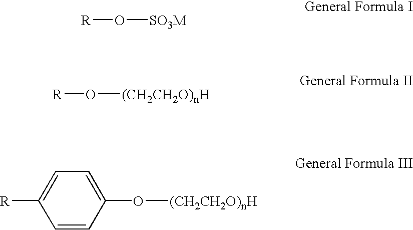
in which “R” denotes substituted or unsubstituted alkyl group, “n” denotes an integer in the range of 3 to 20, and “M” denotes a monovalent metal atom.

4. An optical multi-layer sheet as defined in claim 1, wherein said fine particles are at least any one of polystyrene, polymethylmethacrylate, and silica.

5. An optical multi-layer sheet as defined in claim 4, wherein an average diameter of said fine particles is not less than 0.05 μm and not more than 20.00 μm.

6. An optical multi-layer sheet as defined in claim 5, wherein said fine particles include first monodispersed fine particles and second monodispersed fine particles, average diameters of said first and second monodispersed fine particles being different from each other.

7. An optical multi-layer sheet as defined in claim 1, wherein said protective material is composed of two layers, said two layers being a fine particle-containing layer including fine particles and a binder, and a surface layer including a lubricant and a binder, said fine particles being formed of organic compound or inorganic compound, said binder being a polymer having a glass transition temperature of 40° C. or more, and said surface layer being formed on said fine particle-containing layer.

8. An image display device, comprising a multi-layer sheet as defined in claim 1.
